(19) United States
(12) Patent Application Publication
(10) Pub. No.: US 2018/0196681 A1
(43) Pub. Date: Jul. 12, 2018

(54) SELECTIVE PROCESSOR WAKE-UP IN AN ELECTRONIC DEVICE

(71) Applicant: QUALCOMM Incorporated, San Diego, CA (US)

(72) Inventors: Lior Amarilio, Yokneam (IL); Sharon Graif, Zichron Yaakov (IL); Oren Nishry, Haifa (IL)

(21) Appl. No.: 15/402,631

(22) Filed: Jan. 10, 2017

(51) Int. Cl. G06F 9/44; G06F 13/364; G06F 13/42; G06F 13/40

(52) U.S. Cl. CPC G06F 9/4418; G06F 13/404; G06F 13/4282; G06F 13/364

(57) ABSTRACT

Selective processor wake-up in an electronic device is provided. In one aspect, a master circuit in an electronic device is communicatively coupled to a data bus that includes a primary data line and a plurality of secondary data lines preconfigured to identify a plurality of processors in the electronic device, respectively. The master circuit detects a processor wake-up trigger(s) asserted on a secondary data line(s) and wakes up a target processor(s) identified by the secondary data line(s). In another aspect, a client circuit(s) identifies the secondary data line(s) preconfigured to identify the target processor(s) and asserts the processor wake-up trigger(s) on the secondary data line(s). By conveying the processor wake-up trigger(s) over the secondary data line(s) preconfigured to identify the target processor(s), it may be possible to optimize processor wake-up efficiency and responsiveness in the master circuit, thus leading to improved power consumption and battery life in the electronic device.

### BACKGROUND

### I. Field of the Disclosure

The technology of the disclosure relates generally to processor wake-up in an electronic device.

### II. Background

Electronic devices, such as mobile communication devices, have become increasingly common in current society. The prevalence of these mobile communication devices is driven in part by the many functions that are now enabled on such devices. Increased processing capabilities in such devices means that mobile communication devices have evolved from pure communication tools into sophisticated mobile entertainment centers that enable enhanced user experiences.

Increasingly complex integrated circuits (ICs) have been designed and manufactured to provide greater functionality in a mobile communication device. One such IC is a master circuit for concurrently controlling peripheral devices over a shared data bus. The IC may be provided in an electronic device (e.g., smartphone) that includes multiple processors. The multiple processors can operate individually or collectively to improve performance of the mobile communication device. However, the multiple processors can also lead to increased power consumption and shortened battery life of the mobile communication device.

In this regard, the multiple processors can be configured to enter opportunistically a power-saving mode (e.g., standby or idle) to help conserve power and prolong battery life of the mobile communication device. A main processor (e.g., a bus controller) in the mobile communication device may be configured to be woken up by a specific peripheral device(s). The main processor can be further configured to subsequently wake up a processor(s) among the multiple processors in the mobile communication device to execute a specific command(s), perform a specific computing task(s), and/or launch a specific application(s) for the specific peripheral device(s). In some cases, the main processor is woken up solely for the purpose of waking up the processor(s) that serves the specific peripheral device(s). The main processor can consume additional power and/or cause unnecessary delay in waking up the processor(s). As such, it may be desired to optimize processor wake-up mechanisms employed in the mobile communication device to improve processor wake-up efficiency and responsiveness, thus leading to improved power consumption and battery life of the mobile communication device.

### SUMMARY OF THE DISCLOSURE

Aspects disclosed in the detailed description include selective processor wake-up in an electronic device. In one aspect, a master circuit in an electronic device is communicatively coupled to a data bus that includes a primary data line and a plurality of secondary data lines preconfigured to identify a plurality of processors in the electronic device, respectively. The master circuit detects a processor wake-up trigger(s) asserted on a secondary data line(s) and wakes up a target processor(s) identified by the secondary data line(s). In another aspect, a client circuit(s) is communicatively coupled to the data bus. The client circuit(s) identifies the secondary data line(s) preconfigured to identify the target processor(s) and asserts the processor wake-up trigger(s) on the secondary data line(s). By conveying the processor wake-up trigger(s) over the secondary data line(s) preconfigured to identify the target processor(s), it may be possible to wake up the target processor(s) directly, without involving other component(s) in the electronic device and/or invoking intermediate processing step(s). As a result, it is possible to optimize processor wake-up efficiency and responsiveness in the master circuit, thus leading to improved power consumption and battery life in the electronic device.

In this regard, in one aspect, an electronic device is provided. The electronic device includes a master circuit communicatively coupled to a data bus. The data bus includes a clock line, a primary data line, and a plurality of secondary data lines. The master circuit is configured to detect at least one processor wake-up trigger asserted on at least one selected secondary data line among the plurality of secondary data lines. The master circuit is also configured to determine at least one target processor among a plurality of processors identified by the at least one selected secondary data line. The master circuit is also configured to wake up the at least one target processor identified by the at least one selected secondary data line.

In another aspect, an electronic device is provided. The electronic device includes one or more client circuits communicatively coupled to a data bus. The data bus includes a clock line, a primary data line, and a plurality of secondary data lines. At least one selected client circuit among the one or more client circuits is configured to determine at least one target processor among a plurality of processors to be woken up for a data processing task. The at least one selected client circuit is also configured to identify at least one selected secondary data line among the plurality of secondary data lines configured to identify the at least one target processor. The at least one selected client circuit is also configured to assert at least one processor wake-up trigger on the at least one selected secondary data line.

In another aspect, an electronic device is provided. The electronic device includes a data bus including a clock line, a primary data line, and a plurality of secondary data lines. The electronic device also includes one or more client circuits coupled to the data bus. At least one selected client circuit among the one or more client circuits is configured to determine at least one target processor among a plurality of processors to be woken up for a data processing task. The at least one selected client circuit is also configured to identify at least one selected secondary data line among the plurality of secondary data lines configured to identify the at least one target processor. The at least one selected client circuit is also configured to assert at least one processor wake-up trigger on the at least one selected secondary data line. The electronic device also includes a master circuit coupled to the data bus. The master circuit is configured to detect the at least one processor wake-up trigger asserted on the at least one selected secondary data line among the plurality of secondary data lines. The master circuit is also configured to determine the at least one target processor among the plurality of processors identified by the at least one selected secondary data line. The master circuit is also configured to wake up the at least one target processor identified by the at least one selected secondary data line.

In another aspect, a method for waking up a processor in an electronic device is provided. The method includes determining at least one target processor among a plurality of processors to wake up for a data processing task. The method also includes identifying at least one selected secondary data line among a plurality of secondary data lines in a data bus configured to identify the at least one target processor. The method also includes asserting at least one processor wake-up trigger on the at least one selected secondary data line. The method also includes detecting the at least one processor wake-up trigger asserted on the at least one selected secondary data line among the plurality of secondary data lines. The method also includes determining the at least one target processor among the plurality of processors identified by the at least one selected secondary data line. The method also includes waking up the at least one target processor identified by the at least one selected secondary data line

### BRIEF DESCRIPTION OF THE FIGURES

FIG. 1 is a schematic diagram of an exemplary electronic device configured to wake up a target processor among a plurality of processors based on a conventional processor wake-up mechanism;

FIG. 2 is a schematic diagram of an exemplary electronic device in which a master circuit is configured to wake up at least one target processor among a plurality of processors based on at least one processor wake-up trigger asserted on at least one selected secondary data line among a plurality of secondary data lines in a data bus;

FIG. 3 is a signal flowchart of an exemplary optimized processor wake-up process for optimizing processor wake-up efficiency and responsiveness in the electronic device of FIG. 2;

FIG. 4 is a flowchart providing an exemplary illustration of an optimized processor wake-up signal flow conducted between a selected client circuit and the master circuit of FIG. 2 for waking up the at least one target processor among the plurality of processors;

FIG. 5A is a schematic diagram of an exemplary signal diagram for activating a MIPI Alliance SoundWire bus that can be adapted to wake up the target processor of FIG. 2 in compliance with MIPI Alliance Specification for SoundWire, version 1.0, published on Jan. 21, 2015;

FIG. 5B is a schematic diagram of an exemplary signal diagram for activating a MIPI Alliance Serial Low-power Inter-chip Media Bus (SLIMbus) that can be adapted to wake up the target processor of FIG. 2 in compliance with MIPI Alliance Specification for SLIMbus, version 1.01, released in Dec. 3, 2008; and

FIG. 6 illustrates an exemplary processor-based system that can support the electronic device of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include selective processor wake-up in an electronic device. In one aspect, a master circuit in an electronic device is communicatively coupled to a data bus that includes a primary data line and a plurality of secondary data lines preconfigured to identify a plurality of processors in the electronic device, respectively. The master circuit detects a processor wake-up trigger(s) asserted on a secondary data line(s) and wakes up a target processor(s) identified by the secondary data line(s). In another aspect, a client circuit(s) is communicatively coupled to the data bus. The client circuit(s) identifies the secondary data line(s) preconfigured to identify the target processor(s) and asserts the processor wake-up trigger(s) on the secondary data line(s). By conveying the processor wake-up trigger(s) over the secondary data line(s) preconfigured to identify the target processor(s), it may be possible to wake up the target processor(s) directly, without involving other component(s) in the electronic device and/or invoking intermediate processing step(s). As a result, it is possible to optimize processor wake-up efficiency and responsiveness in the master circuit, thus leading to improved power consumption and battery life in the electronic device.

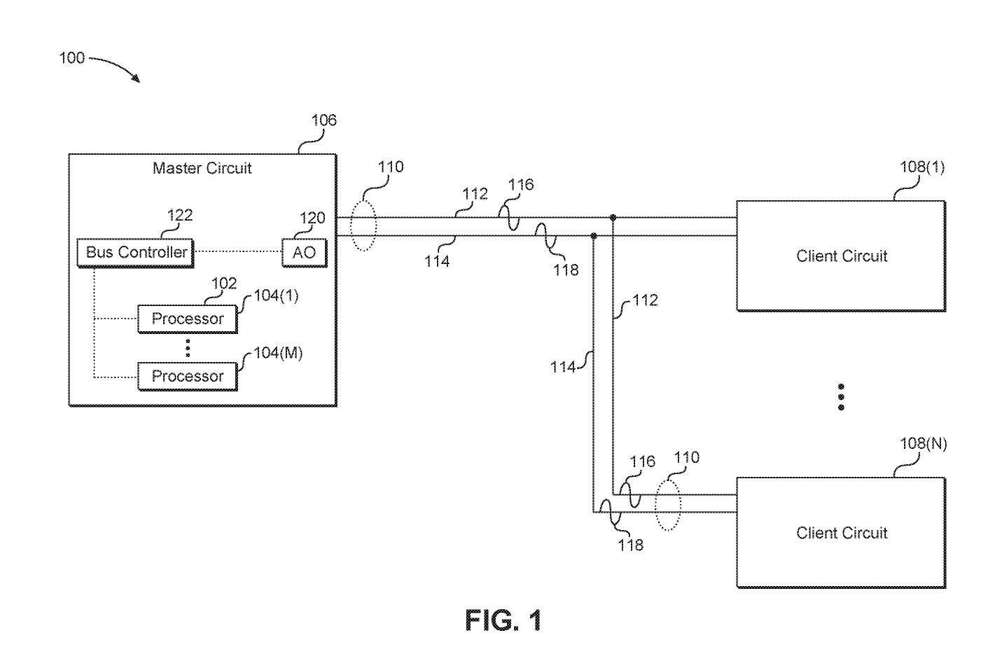

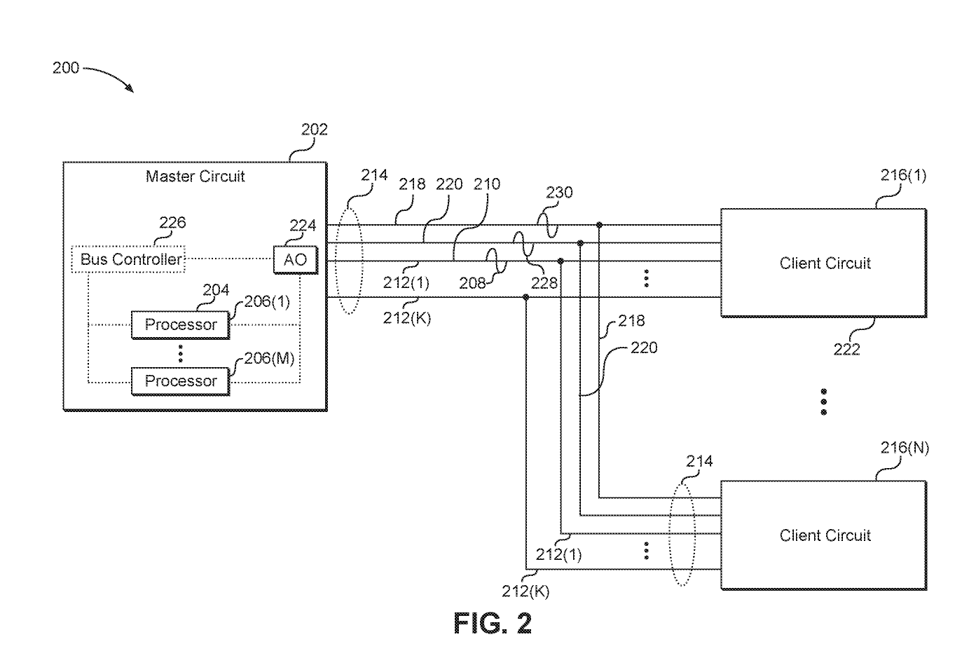

Before discussing exemplary aspects of selective processor wake-up in an electronic device that include specific aspects of the present disclosure, a brief overview of a conventional processor wake-up mechanism is first provided in FIG. 1. The discussion of specific exemplary aspects of selective processor wake-up in an electronic device starts below with reference to FIG. 2.

In this regard, FIG. 1 is a schematic diagram of an exemplary electronic device 100 configured to wake up a target processor 102 among a plurality of processors 104(1)-104(M) based on a conventional processor wake-up mechanism. The electronic device 100 includes a master circuit 106 and one or more client circuits 108(1)-108(N). The master circuit 106 is communicatively coupled to the client circuits 108(1)-108(N) via a data bus 110. In this regard, the data bus 110 is shared between the master circuit 106 and the client circuits 108(1)-108(N). The data bus 110 includes a clock line 112 and a primary data line 114. The master circuit 106 provides a clock signal 116 over the clock line 112 when the data bus 110 is activated. Accordingly, the master circuit 106 and the client circuits 108(1)-108(N) can communicate data over the primary data line 114. The master circuit 106 suspends the clock signal 116 on the clock line 112 when the data bus 110 is deactivated. As a result, the master circuit 106 and the client circuits 108(1)-108(N) stop communicating data over the primary data line 114. A selected client circuit among the client circuits 108(1)-108(N) can submit a bus activation trigger 118 to the master circuit 106 to resume the clock signal 116 on the clock line 112, thus activating the data bus 110, by asserting/toggling the primary data line 114.

In a first non-limiting example, the data bus 110 can be a MIPI Alliance SoundWire (SoundWire) bus. Accordingly, the selected client circuit among the client circuits 108(1)-108(N) can submit the bus activation trigger 118 to request the master circuit 106 to activate the data bus 110 by asserting HIGH on the primary data line 114 for a duration of at least two SoundWire BitSlots, which equals one hundred nanoseconds (100 ns), when the clock signal 116 is at a ten megahertz (10 MHz) frequency.

In a second non-limiting example, the data bus 110 can be a MIPI Alliance Serial Low-power Inter-chip Media Bus (SLIMbus). Accordingly, the selected client circuit among the client circuits 108(1)-108(N) can submit the bus activation trigger 118 to request the master circuit 106 to activate the data bus 110 by toggling the primary data line 114 from the last state held by the last bus holder. The last bus holder can be the master circuit 106 or any of the client circuits 108(1)-108(N). For example, if the last state of primary data line 114 were HIGH, the selected client circuit would toggle the primary data line 114 to LOW as the bus activation trigger 118. In contrast, if the last state of primary data line 114 were LOW, the selected client circuit would toggle the primary data line 114 to HIGH as the bus activation trigger 118.

Notably, the data bus activation mechanisms for activating the SoundWire bus and the SLIMbus can be extended to wake up the target processor 102 among the processors 104(1)-104(M). For the convenience of illustration, the processor 104(1) is discussed herein as an example of the target processor 102. It shall be noted that the target processor 102 can be any one or more of the processors 104(1)-104(M).

With continuing reference to FIG. 1, the master circuit 106 includes an always-on domain 120 (shown in FIG. 1 as “AO”). In a non-limiting example, the always-on domain 120 refers to circuitry in the master circuit 106 that is always powered on. The master circuit 106 also includes a bus controller 122, which can be a main processor dedicated to managing the data bus 110 for example. The always-on domain 120 detects and acknowledges the bus activation trigger 118 submitted from the selected client circuit. In response to receiving the bus activation trigger 118, the always-on domain 120 wakes up the bus controller 122 and activates the data bus 110 by resuming the clock signal 116 on the clock line 112. The bus controller 122 then exchanges a read message(s) with the selected client circuit to determine the target processor 102, which the selected client circuit intends to wake up. Upon determination of the target processor 102, the bus controller 122 wakes up the target processor 102 and then goes to sleep to conserve power. In some cases, the bus controller 122 is woken up solely for the purpose of waking up the target processor 102. As such, the bus controller 122 may consume additional power and/or cause unnecessary delay in waking up the target processor 102.

The conventional processor wake-up mechanism discussed above involves the steps of waking up the data bus 110, waking up the bus controller 122, and determining the target processor 102 via the read message(s) communicated over the data bus 110. Understandably, these additional steps can cause the electronic device 100 to introduce more latency and consume more power for waking up the target processor 102. Hence, it may be desired to improve the conventional process wake-up mechanism to optimize processor wake-up efficiency and responsiveness in the master circuit 106, thus helping to improve power consumption and battery life in the electronic device 100.

The data bus 110 may include a secondary data line(s) in addition to the primary data line 114. For example, the SoundWire bus and the SLIMbus can both provide seven secondary data lines. As discussed in the exemplary aspects below, it is possible to preconfigure a plurality of secondary data lines in a data bus to identify a plurality of processors. As such, a client circuit can wake up a target processor directly by asserting/toggling a secondary data line(s) preconfigured to identify the target processor. Accordingly, a master circuit can wake up the target processor directly based on the asserted secondary data line(s) preconfigured to identify the target processor. In this regard, the target processor can be woken up directly without involving the bus controller 122, thus helping to avoid the additional power consumption and processing delay introduced by the bus controller 122. However, the client circuit may assert/toggle a primary data line, such as the primary data line 114, concurrently to asserting/toggling the secondary data line, thus enabling backward compatibility with the conventional processor wake-up mechanism. In this regard, if the client circuit is a legacy client circuit incapable of waking up the target processor based on the preconfigured secondary data line(s), the client device can wake up the data bus 110 based on the conventional processor wake-up mechanism discussed above. However, if the client circuit is capable of waking up the target processor based on the preconfigured secondary data line(s), the client circuit can be backward compatible with the conventional processor wake-up mechanism by asserting/toggling the secondary data line(s) in addition to asserting/toggling the primary data line 114. As a result, as discussed below, the data bus 110 can be woken up by either the primary data line 114 or the secondary data line(s).

In this regard, FIG. 2 is a schematic diagram of an exemplary electronic device 200 in which a master circuit 202 is configured to wake up at least one target processor 204 among a plurality of processors 206(1)-206(M) based on at least one processor wake-up trigger 208 asserted on at least one selected secondary data line 210 among a plurality of secondary data lines 212(1)-212(K) in a data bus 214. As such, the master circuit 202 can wake up the target processor 204 directly, without involving other component(s) in the electronic device 200 and/or invoking intermediate processing step(s). As a result, it is possible to optimize processor wake-up efficiency and responsiveness in the master circuit 202, thus leading to improved power consumption and battery life in the electronic device 200. The processors 206(1)-206(M) may be provided inside or outside the master circuit 202. For the convenience of reference, the processor 206(1) is discussed hereinafter as a non-limiting example of the target processor 204. It shall be appreciated that any one or more of the processors 206(1)-206(M) can be chosen as the target processor 204.

The master circuit 202 is communicatively coupled to the data bus 214. The electronic device 200 also includes one or more client circuits 216(1)-216(N), which can be audio codecs, microphones, and sensors for example, communicatively coupled to the data bus 214. The secondary data lines 212(1)-212(K) in the data bus 214 are configured to identify the processors 206(1)-206(M). In one exemplary aspect, the number of the processors 206(1)-206(M) equals the number of the secondary data lines 212(1)-212(K) (M=K). In this regard, it is possible to establish a one-to-one matchup between the processors 206(1)-206(M) and the secondary data lines 212(1)-212(K). Table 1 below provides a non-limiting example of the one-to-one matchup between the processors 206(1)-206(M) and the secondary data lines 212(1)-212(K).

TABLE 1

| Processor | Secondary Data line |
|---|---|
| 206(1) | 212(2) |
| 206(2) | 212(K) |
| . | . |
| . | . |
| . | . |
| 206(M) | 212(1) |

In another exemplary aspect, the number of the processors 206(1)-206(M) is greater than the number of the secondary data lines 212(1)-212(K) (M>K). In this regard, it is possible to identify each of the processors 206(1)-206(M) based on combinations of the secondary data lines 212(1)-212(K). For example, it is possible to use a combination of the secondary data lines 212(1), 212(2) to identify the processors 206(1)-206(4), as illustrated in Table 2 below. In this manner, the secondary data lines 212(1)-212(K) can identify up to 2^{K} processors.

TABLE 2

| | Secondary Data line | Secondary Data line |
|---|---|---|
| Processor | 212(1) | 212(2) |
| 206(1) | Not Asserted/Toggled | Not Asserted/Toggled |
| 206(2) | Asserted/Toggled | Not Asserted/Toggled |
| 206(3) | Not Asserted/Toggled | Asserted/Toggled |
| 206(4) | Asserted/Toggled | Asserted/Toggled |

In a non-limiting example, the pre-configuration information can be stored at the master circuit 202 and the client circuits 216(1)-216(N). The data bus 214 also includes a clock line 218, which is equivalent to the clock line 112 of FIG. 1, and a primary data line 220, which is equivalent to the primary data line 114 of FIG. 1. Because the processor wake-up trigger 208 is conveyed via the selected secondary data line 210 as opposed to being conveyed via the primary data line 220, the processor wake-up trigger 208 is also referred to as a sideband processor wake-up trigger.

With continuing reference to FIG. 2, at least one selected client circuit 222, which can be the client circuit 216(1) for example, determines to wake up the target processor 204 for a data processing task (e.g., executing a command, launching an application, etc.). The selected client circuit 222 may determine to wake the target processor 204 in response to an internal triggering event. The selected client circuit 222 then identifies the selected secondary data line 210, which can be the secondary data line 212(1) among the secondary data lines 212(1)-212(K) for example, that is configured to identify the target processor 204. In a non-limiting example, the selected client circuit 222 can identify the selected secondary data line 210 based on the pre-configuration information stored at the selected client circuit 222. The selected client circuit 222 can thus assert the processor wake-up trigger 208 on the selected secondary data line 210 to wake up the target processor 204. It shall be appreciated that the target processor 204 is by no means limited to a single processor. In this regard, the selected client circuit 222 can wake up multiple processors among the processors 206(1)-206(M) concurrently by asserting the processor wake-up trigger 208 on the selected secondary data line 210 configured to identify the multiple processors. For example, the selected client circuit 222 can be an audio codec that can wake up the target processor 204 in response to hot-word detection and wake up a second processor among the processors 206(1)-206(M) in response to user-button press.

The master circuit 202 includes an always-on domain 224 (shown as “AO” in FIG. 2), which can be circuitry in the master circuit 202 that is powered on all the time. The always-on domain 224 monitors the primary data line 220 and the secondary data lines 212(1)-212(K) to detect the processor wake-up trigger 208 asserted on the selected secondary data line 210. The always-on domain 224 determines the target processor 204 that is identified by the selected secondary data line 210. In a non-limiting example, the always-on domain 224 can determine the target processor 204 identified by the selected secondary data line 210 based on the pre-configuration information stored at the master circuit 202. The always-on domain 224 then wakes up the target processor 204, which may be configured to wake up the data bus 214 for communication with the selected client circuit 222. In this regard, it is possible to wake up the target processor 204 via the selected secondary data line 210 pre-configured to identify the target processor 204. As a result, it is not necessary to perform the steps of waking up the bus controller 122 and determining the target processor 102 via the read message(s), as required by the conventional processor wake-up mechanism of FIG. 1. Hence, it may be possible to optimize processor wake-up efficiency and responsiveness in the master circuit 202, thus helping to improve power consumption and battery life in the electronic device 200.

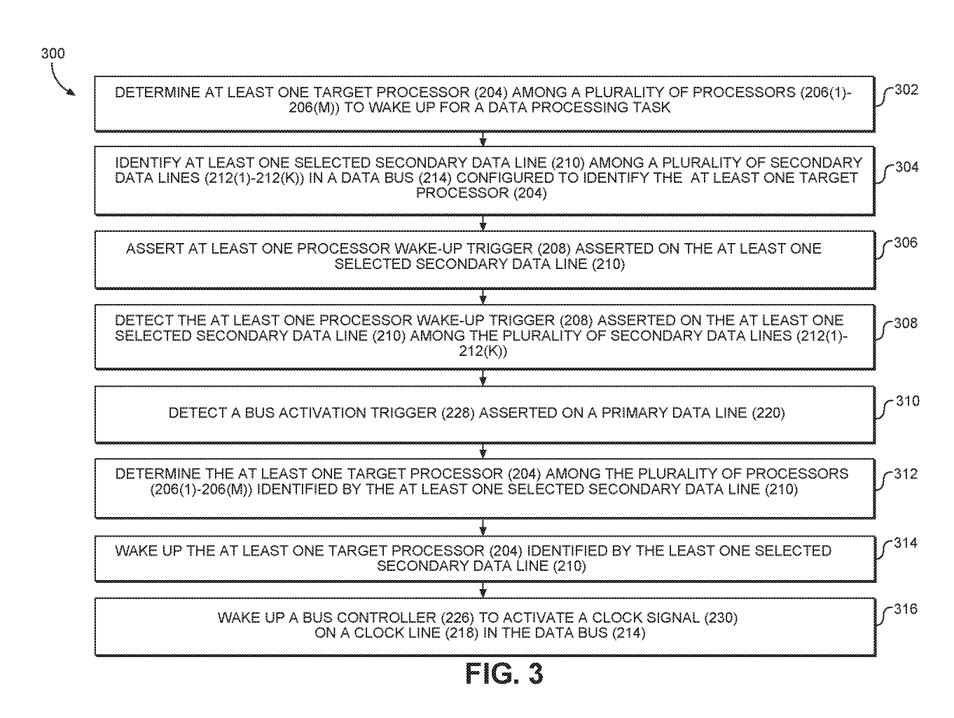

The electronic device 200 can be configured to wake up the target processor 204 according to an optimized processor wake-up process. In this regard, FIG. 3 is a signal flowchart of an exemplary optimized processor wake-up process 300 for optimizing processor wake-up efficiency and responsiveness in the electronic device 200 of FIG. 2.

With reference to FIG. 3, the selected client circuit 222 determines the target processor 204 among the processors 206(1)-206(M) to wake up for a data processing task (block 302). The selected client circuit 222 identifies the selected secondary data line 210 among the secondary data lines 212(1)-212(K) in the data bus 214 configured to identify the target processor 204 (block 304). The selected client circuit 222 may identify the selected secondary data line 210 based on Table 1 or the Table 2 above. The selected client circuit 222 asserts the processor wake-up trigger 208 on the selected secondary data line 210 (block 306).

The always-on domain 224 detects the processor wake-up trigger 208 asserted on the selected secondary data line 210 among the secondary data lines 212(1)-212(K) (block 308). When the selected client circuit 222 is configured to be backward compatible with the conventional processor wake-up mechanism of FIG. 1, the selected client circuit 222 will assert the bus activation trigger 228 concurrently on the primary data line 220. As such, the always-on domain 224 will detect the bus activation trigger 228 asserted on the primary data line 220 as well (block 310). The always-on domain 224 determines the target processor 204 identified by the selected secondary data line 210 among the processors 206(1)-206(M) (block 312). The selected always-on domain 224 may identify the target processor 204 based on Table 1 or the Table 2 above. The always-on domain 224 wakes up the target processor 204 identified by the selected secondary data line 210 (block 314). The always-on domain 224 then wakes up the bus controller 226 to activate the clock signal 230 on the clock line 218 in the data bus 214 (block 316).

With reference back to FIG. 2, the master circuit 202 may include a bus controller 226 configured to assume similar functions as the bus controller 122 of FIG. 1. As discussed below, by including the bus controller 226 in the master circuit 202, the master circuit 202 can be backward compatible with the conventional processor wake-up scheme of FIG. 1. In this regard, the selected client circuit 222 may be configured to assert a bus activation trigger 228 on the primary data line 220 substantially concurrent to asserting the processor wake-up trigger 208 on the selected secondary data line 210. The always-on domain 224 detects the bus activation trigger 228 asserted on the primary data line 220 and wakes up the bus controller 226 to activate a clock signal 230 on the clock line 218 in response to detecting the bus activation trigger 228 on the primary data line 220. In a non-limiting example, the always-on domain 224 can detect the processor wake-up trigger 208 asserted on the selected secondary data line 210 substantially concurrent to detecting the bus activation trigger 228 asserted on the primary data line 220. By being able to detect the bus activation trigger 228 asserted on the primary data line 220, the master circuit 202 could be backward compatible with the conventional processor wake-up mechanism described in FIG. 1.

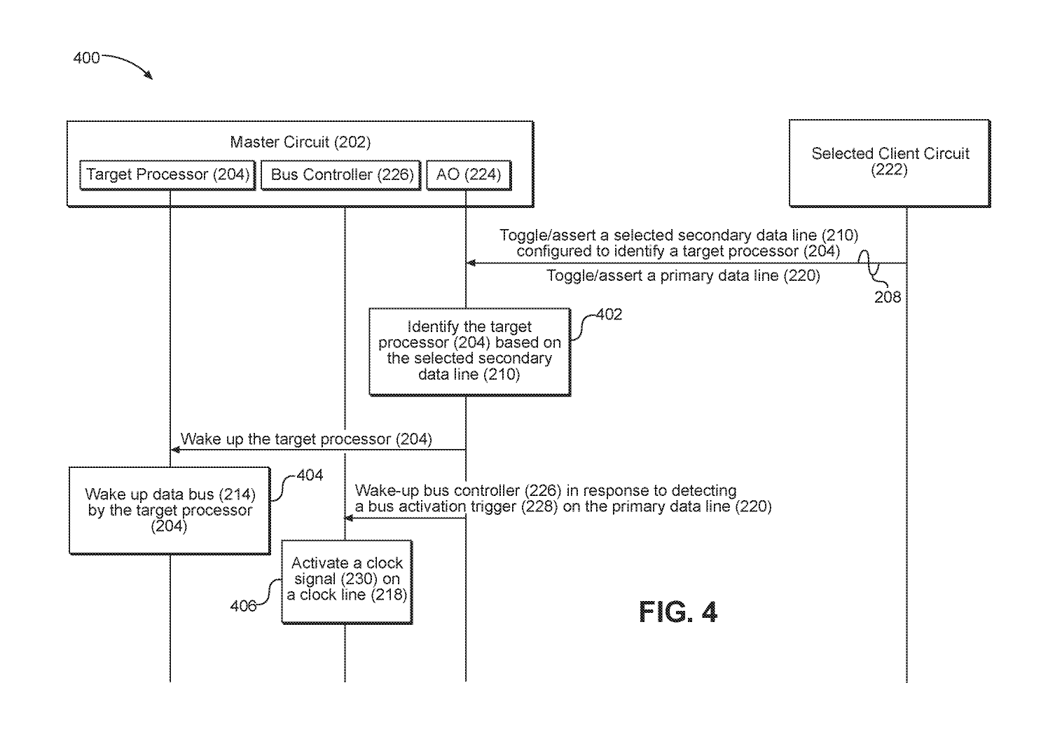

According to previous discussions, by waking up the target processor 204 via the selected secondary data line 210 pre-configured to identify the target processor 204, it is no longer necessary to perform the steps of waking up the bus controller 122 and determining the target processor 102 via the read message(s), as required by the conventional processor wake-up mechanism of FIG. 1. In this regard, FIG. 4 is a flowchart providing an exemplary illustration of an optimized processor wake-up signal flow 400 conducted between the selected client circuit 222 and the master circuit 202 of FIG. 2 for waking up the target processor 204 among the processors 206(1)-206(M). Common elements between FIGS. 2 and 4 are shown therein with common element numbers and will not be re-described herein.

With reference to FIG. 4, the selected client circuit 222 asserts the processor wake-up trigger 208 by toggling/asserting the selected secondary data line 210 that is configured to identify the target processor 204. To maintain backward compatibility, the selected client circuit 222 also asserts the bus activation trigger 228 by toggling/asserting the primary data line 220. The always-on domain 224 (shown as “AO” in FIG. 4) identifies the target processor 204 based on the selected secondary data line 210 asserted by the selected client circuit 222 (block 402). The always-on domain 224 subsequently wakes up the target processor 204. Upon wake-up, the target processor 204 may wake up the data bus 214 (block 404). In response to detecting the bus activation trigger 228 on the primary data line 220, the always-on domain 224 further wakes up the bus controller 226. The bus controller 226 then activates the clock signal 230 on the clock line 218 (block 406). In this regard, the optimized processor wake-up signal flow 400 conducted between the selected client circuit 222 and the master circuit 202 can effectively eliminate the steps of waking up the data bus 110, waking up the bus controller 122, and determining the target processor 102 via the read message(s), as required by the conventional processor wake-up mechanism of FIG. 1. As a result, the optimized processor wake-up signal flow 400 is more efficient than the conventional processor wake-up mechanism of FIG. 1.

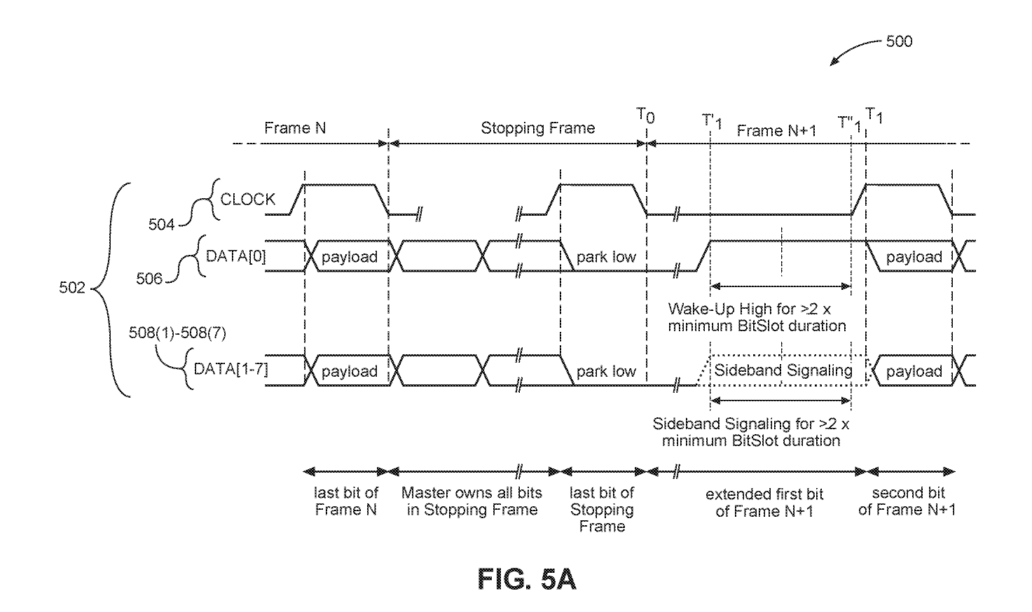

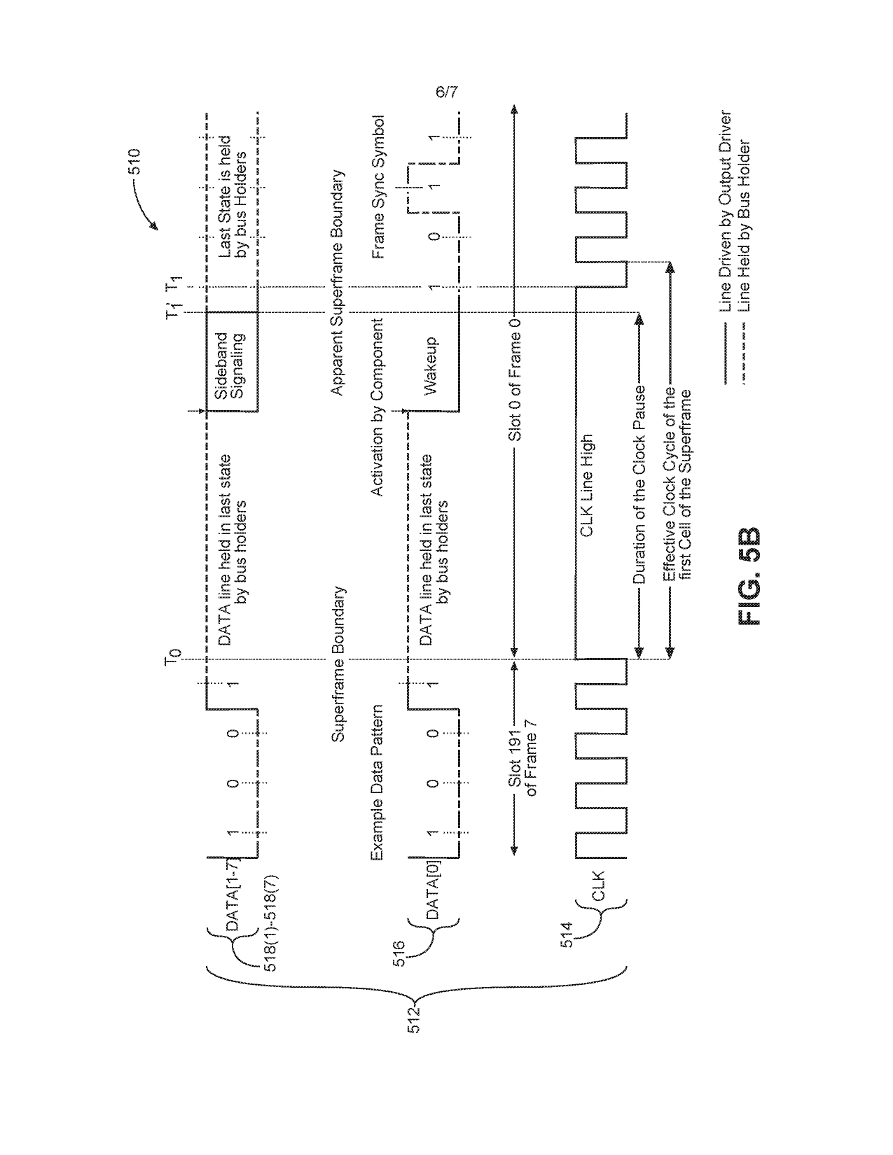

In one exemplary aspect, the data bus 214 of FIG. 2 can be a SoundWire bus. As such, the optimized processor wake-up signal flow 400 of FIG. 4 can be adapted to comply with data bus activation signaling defined in the MIPI Alliance Specification for SoundWire, version 1.0, published on Jan. 21, 2015 (hereinafter referred to as “SoundWire Specification”). In this regard, FIG. 5A is a schematic diagram of an exemplary signal diagram 500 for activating a SoundWire bus 502 that can be adapted to wake up the target processor 204 of FIG. 2 in compliance with the SoundWire Specification. Common elements between FIGS. 2 and 5A are shown therein with common element numbers and will not be re-described herein.

With reference to FIG. 5A, the SoundWire bus 502 includes a clock line 504 for communicating a clock signal CLOCK, a primary data line 506 for communicating a primary data signal DATA[0], and seven secondary data lines 508(1)-508(7) for respectively communicating seven secondary data signals DATA[1-7]. The clock line 504 is equivalent to the clock line 112 of FIG. 1 and the clock line 218 of FIG. 2. The primary data line 506 is equivalent to the primary data line 114 of FIG. 1 and the primary data line 220 of FIG. 2. The secondary data lines 508(1)-508(7) are equivalent to the secondary data lines 212(1)-212(K) (K=7), respectively.

As illustrated in FIG. 5A, at time T₀, the clock line 504, the primary data line 506, and the secondary data lines 508(1)-508(7) are held LOW. As a result, the clock signal CLOCK is suspended, thus causing the SoundWire bus 502 to be deactivated. At time T′₁, the primary data line 506 is asserted HIGH. Subsequently at time T₁, the clock signal CLOCK is resumed and the SoundWire bus 502 is activated. The duration between time T′₁ and time T₁ can last, for example, over 100 milliseconds (ms). Accordingly, the selected client circuit 222 can provide the processor wake-up trigger 208 to the master circuit 202 for waking up the target processor 204 by asserting the selected secondary data line 210 (e.g., the secondary data line 508(1)) as HIGH for a predetermined duration between time T′₁ and time T″₁, which is earlier than T₁. In a first non-limiting example, the predetermined duration can be two SoundWire BitSlots, which is equal to 100 ns when the clock signal CLOCK is at the ten megahertz (10 MHz) frequency. Although the duration between T′₁ and time T″₁ can be relatively short, the duration between T′₁ and time T″₁ is typically longer than two SoundWire BitSlots. In a second non-limiting example, the predetermined duration can be as short as one (1) ns. In response to detecting the selected secondary data line 210 being asserted as HIGH for the predetermined duration, the master circuit 202 can wake up the target processor 204 based on the process discussed above in FIGS. 2-4.

According to previous discussions in FIG. 2, the selected client circuit 222 may be configured to assert the bus activation trigger 228 on the primary data line 506 to activate the SoundWire bus 502, thus being backward compatible with the SoundWire Specification. In this regard, the selected client circuit 222 may assert the processor wake-up trigger 208 on the selected secondary data line 210 substantially concurrent to asserting the bus activation trigger 228 on the primary data line 506.

In another exemplary aspect, the data bus 214 of FIG. 2 can be a SLIMbus. As such, the optimized processor wake-up signal flow 400 of FIG. 4 can be adapted to comply with data bus activation signaling defined in the MIPI Alliance Specification for SLIMbus, version 1.01, released in Dec. 3, 2008 (hereinafter referred to as “SLIMbus Specification”). In this regard, FIG. 5B is a schematic diagram of an exemplary signal diagram 510 for activating a SLIMbus 512 that can be adapted to wake up the target processor 204 of FIG. 2 in compliance with the SLIMbus Specification. Common elements between FIGS. 2 and 5B are shown therein with common element numbers and will not be re-described herein.

With reference to FIG. 5B, the SLIMbus 512 includes a clock line 514 for communicating a clock signal CLK, a primary data line 516 for communicating a primary data signal DATA[0], and seven secondary data lines 518(1)-518(7) for respectively communicating seven secondary data signals DATA[1-7]. The clock line 514 is equivalent to the clock line 112 of FIG. 1 and the clock line 218 of FIG. 2. The primary data line 516 is equivalent to the primary data line 114 of FIG. 1 and the primary data line 220 of FIG. 2. The secondary data lines 518(1)-518(7) are equivalent to the secondary data lines 212(1)-212(K) (K=7), respectively.

As illustrated in FIG. 5B, at time T₀, the clock signal CLK is suspended by being held as HIGH, thus causing the SLIMbus 512 to be deactivated. At time T₁, the clock signal CLK is resumed, thus causing the SLIMbus 512 to be activated. The duration between time T₀ and time T₁ can last, for example, over 100 milliseconds (ms). In a non-limiting example, the secondary data lines 518(1)-518(7) are held as HIGH (the “last state”) when the SLIMbus 512 is deactivated at time T₀. In this regard, to wake up the target processor 204, the selected client circuit 222 can provide the processor wake-up trigger 208 to the master circuit 202 by toggling the selected secondary data line 210 (e.g., the secondary data line 518(1)) from HIGH (the “last state”) to LOW (the “current state”) between time T₀ and time T′₁, which may be earlier than time T₁ by at least one-half cycle of the clock signal CLK. In another non-limiting example, the secondary data lines 518(1)-518(7) are held as LOW (the “last state”) when the SLIMbus 512 is deactivated at time T₀. In this regard, to wake up the target processor 204, the selected client circuit 222 can provide the processor wake-up trigger 208 to the master circuit 202 by toggling the selected secondary data line 210 from LOW (the “last state”) to HIGH (the “current state”) between time T₀ and time T′₁. In response to detecting the selected secondary data line 210 being toggled from the last state to the current state, the master circuit 202 can wake up the target processor 204 based on the process discussed above in FIGS. 2-4.

According to previous discussions in FIG. 2, the selected client circuit 222 may be configured to assert the bus activation trigger 228 on the primary data line 516 to activate the SLIMbus 512, thus being backward compatible with the SLIMbus Specification. In this regard, the selected client circuit 222 may assert the processor wake-up trigger 208 on the selected secondary data line 210 substantially concurrent to asserting the bus activation trigger 228 on the primary data line 516.

Selective processor wake-up in an electronic device according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

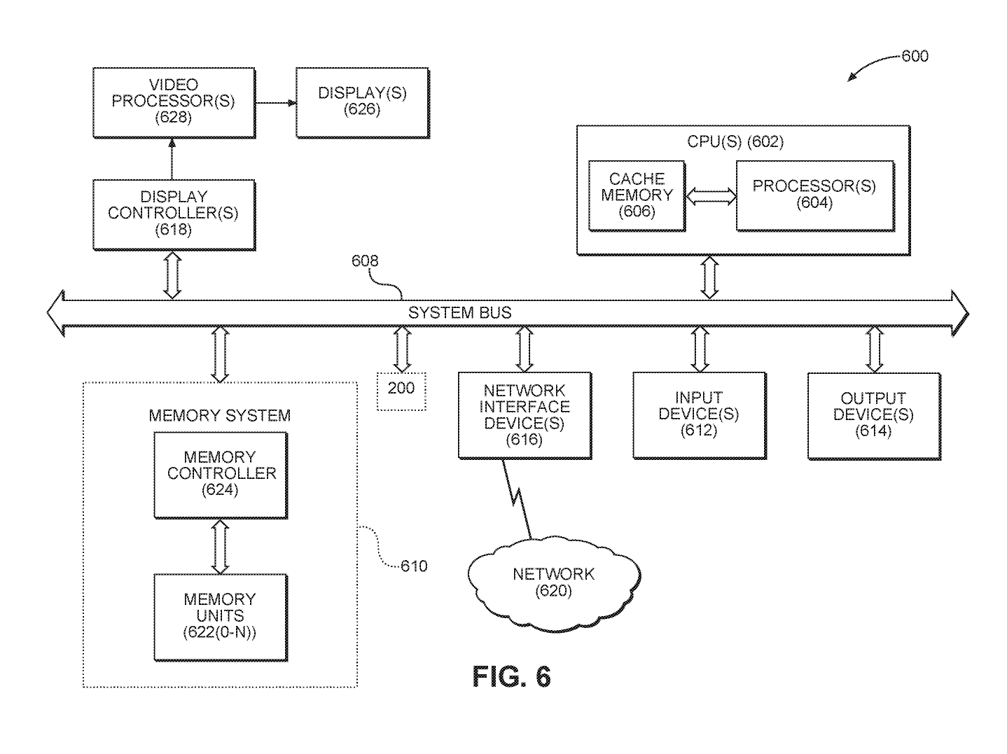

In this regard, FIG. 6 illustrates an exemplary processor-based system 600 that can support the electronic device 200 of FIG. 2. In this example, the processor-based system 600 includes one or more central processing units (CPUs) 602, each including one or more processors 604. The CPU(s) 602 may have cache memory 606 coupled to the processor(s) 604 for rapid access to temporarily stored data. The CPU(s) 602 is coupled to a system bus 608. As is well known, the CPU(s) 602 communicates with other devices by exchanging address, control, and data information over the system bus 608. Although not illustrated in FIG. 6, multiple system buses 608 could be provided, wherein each system bus 608 constitutes a different fabric.

Other master and slave devices can be connected to the system bus 608. As illustrated in FIG. 6, these devices can include a memory system 610, one or more input devices 612, one or more output devices 614, one or more network interface devices 616, and one or more display controllers 618, as examples. The input device(s) 612 can include any type of input device, including, but not limited to, input keys, switches, voice processors, etc. The output device(s) 614 can include any type of output device, including, but not limited to, audio, video, other visual indicators, etc. The network interface device(s) 616 can be any device configured to allow exchange of data to and from a network 620. The network 620 can be any type of network, including, but not limited to, a wired or wireless network, a private or public network, a local area network (LAN), a wireless local area network (WLAN), a wide area network (WAN), a BLUETOOTH™ network, or the Internet. The network interface device(s) 616 can be configured to support any type of communications protocol desired. The memory system 610 can include one or more memory units 622(0-N) and a memory controller 624.

The CPU(s) 602 may also be configured to access the display controller(s) 618 over the system bus 608 to control information sent to one or more displays 626. The display controller(s) 618 sends information to the display(s) 626 to be displayed via one or more video processors 628, which process the information to be displayed into a format suitable for the display(s) 626. The display(s) 626 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An electronic device, comprising:
a master circuit communicatively coupled to a data bus comprising a clock line, a primary data line, and a plurality of secondary data lines;
wherein the master circuit is configured to:
detect at least one processor wake-up trigger asserted on at least one selected secondary data line among the plurality of secondary data lines;
determine at least one target processor among a plurality of processors identified by the at least one selected secondary data line; and
wake up the at least one target processor identified by the at least one selected secondary data line.

2. The electronic device of claim 1, wherein the master circuit comprises an always-on domain configured to:
detect the at least one processor wake-up trigger asserted on the at least one selected secondary data line among the plurality of secondary data lines;
determine the at least one target processor among the plurality of processors identified by the at least one selected secondary data line; and
wake up the at least one target processor identified by the at least one selected secondary data line.

3. The electronic device of claim 1, wherein the at least one target processor is configured to activate the data bus.

4. The electronic device of claim 1, wherein the master circuit is further configured to:
detect a bus activation trigger asserted on the primary data line; and
wake up a bus controller to activate a clock signal on the clock line in response to detecting the bus activation trigger asserted on the primary data line.

5. The electronic device of claim 4, wherein the master circuit is configured to detect the at least one processor wake-up trigger asserted on the at least one selected secondary data line substantially concurrent to detecting the bus activation trigger asserted on the primary data line.

6. The electronic device of claim 1, wherein:
the data bus comprises a MIPI Alliance SoundWire (SoundWire) bus; and
the master circuit is configured to detect the at least one processor wake-up trigger in response to the at least one selected secondary data line being asserted as HIGH for a predetermined duration.

7. The electronic device of claim 1, wherein:
the data bus comprises a MIPI Alliance Serial Low-power Inter-chip Media Bus (SLIMbus); and
the master circuit is configured to detect the at least one processor wake-up trigger in response to the at least one selected secondary data line being toggled from a last state to a current state different from the last state.

8. An electronic device, comprising:
one or more client circuits communicatively coupled to a data bus comprising a clock line, a primary data line, and a plurality of secondary data lines;
wherein at least one selected client circuit among the one or more client circuits is configured to:
determine at least one target processor among a plurality of processors to be woken up for a data processing task;
identify at least one selected secondary data line among the plurality of secondary data lines configured to identify the at least one target processor; and
assert at least one processor wake-up trigger on the at least one selected secondary data line.

9. The electronic device of claim 8, wherein the at least one selected client circuit is further configured to assert a bus activation trigger on the primary data line to activate a clock signal on the clock line.

10. The electronic device of claim 9, wherein the at least one selected client circuit is configured to assert the at least one processor wake-up trigger on the at least one selected secondary data line substantially concurrent to asserting the bus activation trigger on the primary data line.

11. The electronic device of claim 8, wherein:
the data bus comprises a MIPI Alliance SoundWire (SoundWire) bus; and
the at least one selected client circuit is configured to assert the at least one processor wake-up trigger by asserting the at least one selected secondary data line as HIGH for a predetermined duration.

12. The electronic device of claim 8, wherein:
the data bus comprises a MIPI Alliance Serial Low-power Inter-chip Media Bus (SLIMbus); and
the at least one selected client circuit is configured to provide the at least one processor wake-up trigger by toggling the at least one selected secondary data line from a last state to a current state different from the last state.

13. An electronic device, comprising:
a data bus comprising a clock line, a primary data line, and a plurality of secondary data lines;
one or more client circuits coupled to the data bus, wherein at least one selected client circuit among the one or more client circuits is configured to:
determine at least one target processor among a plurality of processors to be woken up for a data processing task;
identify at least one selected secondary data line among the plurality of secondary data lines configured to identify the at least one target processor; and
assert at least one processor wake-up trigger on the at least one selected secondary data line; and
a master circuit coupled to the data bus, the master circuit configured to:
detect the at least one processor wake-up trigger asserted on the at least one selected secondary data line among the plurality of secondary data lines;
determine the at least one target processor among the plurality of processors identified by the at least one selected secondary data line; and
wake up the at least one target processor identified by the at least one selected secondary data line.

14. The electronic device of claim 13, wherein the master circuit comprises the plurality of processors.

15. The electronic device of claim 13, wherein the master circuit comprises an always-on domain configured to:
detect the at least one processor wake-up trigger asserted on the at least one selected secondary data line among the plurality of secondary data lines;
determine the at least one target processor among the plurality of processors identified by the at least one selected secondary data line; and
wake up the at least one target processor identified by the at least one selected secondary data line.

16. The electronic device of claim 13, wherein the at least one target processor is configured to activate the data bus.

17. The electronic device of claim 13, wherein:
the at least one selected client circuit is further configured to assert a bus activation trigger on the primary data line to activate a clock signal on the clock line; and
the master circuit is further configured to:
detect the bus activation trigger asserted on the primary data line; and
wake up a bus controller to activate the clock signal on the clock line in response to detecting the bus activation trigger asserted on the primary data line.

18. The electronic device of claim 17, wherein:
the at least one selected client circuit is configured to assert the at least one processor wake-up trigger on the at least one selected secondary data line substantially concurrent to asserting the bus activation trigger on the primary data line; and
the master circuit is configured to detect the at least one processor wake-up trigger asserted on the at least one selected secondary data line substantially concurrent to detecting the bus activation trigger asserted on the primary data line.

19. The electronic device of claim 13, wherein:
the data bus comprises a MIPI Alliance SoundWire (SoundWire) bus;
the at least one selected client circuit is configured to assert the at least one processor wake-up trigger by asserting the at least one selected secondary data line being held as HIGH for a predetermined duration; and
the master circuit is configured to detect the at least one processor wake-up trigger in response to the at least one selected secondary data line being asserted as HIGH for the predetermined duration.

20. The electronic device of claim 13, wherein:
the data bus comprises a MIPI Alliance Serial Low-power Inter-chip Media Bus (SLIMbus);
the at least one selected client circuit is configured to assert the at least one processor wake-up trigger by toggling the at least one selected secondary data line from a last state to a current state different from the last state; and
the master circuit is configured to detect the at least one processor wake-up trigger in response to the at least one selected secondary data line being toggled from the last state to the current state.
